(19) United States
(12) Patent Application Publication
(10) Pub. No.: US 2014/0085343 A1
(43) Pub. Date: Mar. 27, 2014

(54) METHOD, APPARATUS, AND TERMINAL FOR ADJUSTING DISPLAY AREA OF PAGE

(71) Applicant: HUAWEI DEVICE CO., LTD., Shenzhen (CN)

(72) Inventor: Wei WANG, Xi'an (CN)

(73) Assignee: HUAWEI DEVICE CO., LTD., Shenzhen (CN)

(21) Appl. No.: 14/092,315

(22) Filed: Nov. 27, 2013

Related U.S. Application Data
(63) Continuation of application No. PCT/CN2011/074875, filed on May 30, 2011.

(51) Int. Cl. G09G 5/38

(52) U.S. Cl. CPC G09G 5/38
USPC 345/676

(57) ABSTRACT

The present invention discloses a method, an apparatus, and a terminal for adjusting a display area of a page. The method includes: obtaining displacement of a mobile communication terminal from a first time point to a second time point; and adjusting a display area of a currently browsed page according to the displacement. Through technical solutions of the present invention, a user may adjust the display area of the page through the mobile communication terminal, so as to solve a problem in the prior art that a mis-operation is easily caused when the display area of the page is adjusted in a manner of dragging on a touchscreen.

### CROSS-REFERENCE TO RELATED APPLICATIONS

This application is a continuation of International Application No. PCT/CN2011/074875, filed on May 30, 2011, which is hereby incorporated by reference in its entirety.

### TECHNICAL FIELD

The present invention relates to the field of communications technologies, and particularly to a method, an apparatus, and a terminal for adjusting a display area of a page.

### BACKGROUND

Recently, a commonly used cell phone has an Internet access function, and a user may browse a web page by using a browser of the cell phone. However, a size of the web page usually exceeds a size of a display screen of the cell phone, which results in that the display screen can only display a small part of the entire web page. In this way, when browsing the web page, the user needs to adjust a display area of the web page, so as to browse the entire web page.

In the prior art, there are the following two methods for adjusting a display area of a web page:

One is that the browser re-typesets the web page, so as to make a width of the web page after the re-typesetting consistent with a width of the display screen. Therefore, the user scrolls the web page up and down by using a navigation key of the cell phone, so as to browse the entire web page. However, by adopting the method, the web page after the re-typesetting is usually modified beyond recognition, the content of which is confusing, which cannot provide good user experience.

The other one is that the web page is controlled to move up and down, left and right in a manner of dragging on a touchscreen, so as to adjust the display area of the web page. By adopting the method, an original appearance of the web page may be kept, but a mis-operation may be easily caused. For example, when the web page has many hyperlinks, an operation of dragging the web page may be easily confused with an operation of clicking on the hyperlink, so that an original operation of dragging the web page may become the operation of clicking on the hyperlink.

### SUMMARY

Embodiments of the present invention provide a method, an apparatus, and a terminal for adjusting a display area of a page.

A method for adjusting a display area of a page includes:

obtaining displacement of a mobile communication terminal from a first time point to a second time point; and

adjusting a display area of a currently browsed page according to the displacement.

An apparatus for adjusting a display area of a page includes:

a displacement obtaining module, configured to obtain displacement of a mobile communication terminal from a first time point to a second time point; and

an adjusting module, configured to adjust a display area of a currently browsed page according to the displacement.

A mobile communication terminal includes a display screen and the apparatus for adjusting a display area of a page.

In the embodiments of the present invention, a technical solution of obtaining the displacement of the mobile communication terminal, and adjusting the display area of the currently browsed page according to the displacement is adopted, so that a user may adjust the display area of the page by moving the mobile communication terminal, so as to solve a problem of a method in the prior art that a mis-operation is easily caused.

### BRIEF DESCRIPTION OF DRAWINGS

FIG. 1 is a flowchart of a method for adjusting a display area of a page according to an embodiment of the present invention;

FIG. 2 is a flowchart of a method for adjusting a display area of a page according to another embodiment of the present invention;

FIG. 3 is a schematic diagram of adjusting a display area of a page according to another embodiment of the present invention;

FIG. 4 is a structural diagram of an apparatus for adjusting a display area of a page according to an embodiment of the present invention; and

FIG. 5 is a structural diagram of an apparatus for adjusting a display area of a page according to another embodiment of the present invention.

### DESCRIPTION OF EMBODIMENTS

Embodiments of the present invention provide a method for adjusting a display area of a page, and a technical solution of adjusting a display area of a currently browsed page according to displacement of a mobile communication terminal is adopted, so that a user may adjust the display area of the page by moving the mobile communication terminal, so as to solve a problem of a method in the prior art that a mis-operation is easily caused. Embodiments of the present invention further provide a corresponding apparatus and a corresponding terminal. Detailed description is given in the following separately.

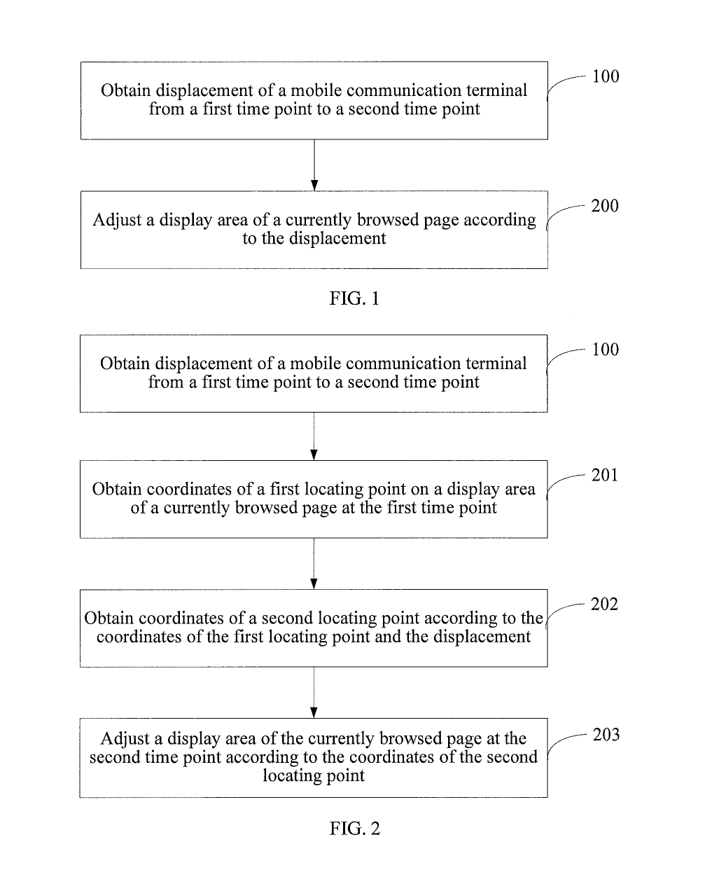

Referring to FIG. 1, an embodiment of the present invention provides a method for adjusting a display area of a page, where the method includes:

100: Obtain displacement of a mobile communication terminal from a first time point to a second time point.

In this embodiment, the displacement of the mobile communication terminal is obtained by using an acceleration sensor. The mentioned displacement is a vector, which not only represents a distance of a movement, but also represents a direction of the movement.

The acceleration sensor is a sensor capable of sensing acceleration and converting the acceleration to an available output signal, and the acceleration sensed by the acceleration sensor may be a constant, and may also be a variable. A working principle of the acceleration sensor is an inertia principle, that is, balance of force. According to a formula, acceleration (A)=inertia force (F)/mass (M), where the mass is known, and if the acceleration is wanted, it only needs to measure the inertia force. The inertia force is balanced by using electromagnetic force, so as to obtain correspondence between current magnitude and the inertia force. Therefore, the inertia force may be obtained by measuring a current, so as to further obtain the acceleration.

The acceleration sensor disposed inside the mobile communication terminal may detect acceleration of the mobile communication terminal between any two time points, for example, the first time point and the second time point, where the acceleration may be a constant, and may also be a variable. Then, according to a formula: displacement=speed×time=(acceleration×time)×time, on the basis of knowing the acceleration, an integral of the acceleration from the first time point to the second time point is calculated, so as to obtain the displacement of the mobile communication terminal from the first time point to the second time point.

An example is taken in the following for description:

It is assumed that acceleration of the mobile communication terminal from a first time point t₀ to a second time point t₁ is a.

Displacement S is an integral of a speed v relative to time t, and there is the following formula:

S=∫_{t0→t1}Vdt

The speed v is an integral of the acceleration a relative to the time t, and there is the following formula:

v=∫_{t0→t1}adt

The foregoing two formulas are combined, so as to obtain S=∫_{t0→t1}(v₀+∫_{t0→t1}adt)dt.

It is assumed that v₀=0, a relationship between the displacement s and the acceleration a is as follows:

S=∫_{t0→t1}(0+∫_{t0→t1}adt)dt=∫_{t0→t1}∫_{t0→t1}adt

Therefore, on the basis that the acceleration sensor has known the acceleration, the integral of the acceleration from the first time point to the second time point is calculated, so as to obtain the displacement of the mobile communication terminal.

200: Adjust a display area of a currently browsed page according to the displacement.

The mentioned display area is an area which has a same size as that of a display screen of the mobile communication terminal and is on the currently browsed page, and may be entirely displayed on the display screen. After the displacement of the mobile communication terminal from the first time point to the second time point is obtained, a negative value of the displacement may be used as displacement for which the currently browsed page needs to be moved, and the page is moved relative to the display screen of the mobile communication terminal, so as to adjust the display area of the page. For example, the mobile communication terminal is moved to a left side for 3 centimeters, the currently browsed page may be moved to a right side relative to the display screen for 3 centimeters. The displacement for which the page is moved may be equal and may also be not equal to the displacement for which the mobile communication terminal is moved. In an implementation manner, conversion may be performed according to a preset proportion, for example, the displacement for which the page is moved may be a half or twice of the displacement for which the mobile communication terminal is moved, and so on.

The mentioned page may be electronic document pages of various formats, such as a web page, or a page of a portable document format (Portable Document Format, PDF) document, or a page of a Microsoft word processing program (Microsoft Word) document, or an e-mail page.

By adopting the method in the embodiment of the present invention, a user may adjust the display area of the currently browsed page by moving the mobile communication terminal, so as to solve a problem in the prior art that a mis-operation is easily caused when the display area of the page is adjusted in a manner of dragging on a touchscreen.

As shown in FIG. 2, in an embodiment, step 200 may specifically include:

201: Obtain coordinates of a first locating point of a display area of the currently browsed page at the first time point.

The mentioned locating point is a point which coincides with a display origin point of the display screen and is on the currently browsed page. The mentioned display origin point may be a pre-defined point on the display screen, for example, a central point or a vertex of the display screen, and certainly, may also be a point of any other position. The display area at the first time point is an area of the currently browsed page displayed on the display screen at the first time point. Therefore, the display area and the locating point have unique correspondence, the locating point may be determined according to the display area, and the display area may also be determined according to the locating point. At any time point, a point which coincides with the display origin point of the display screen and is on a current display area is a locating point corresponding to the time point. An example is taken for description with reference to an accompanying drawing in the following.

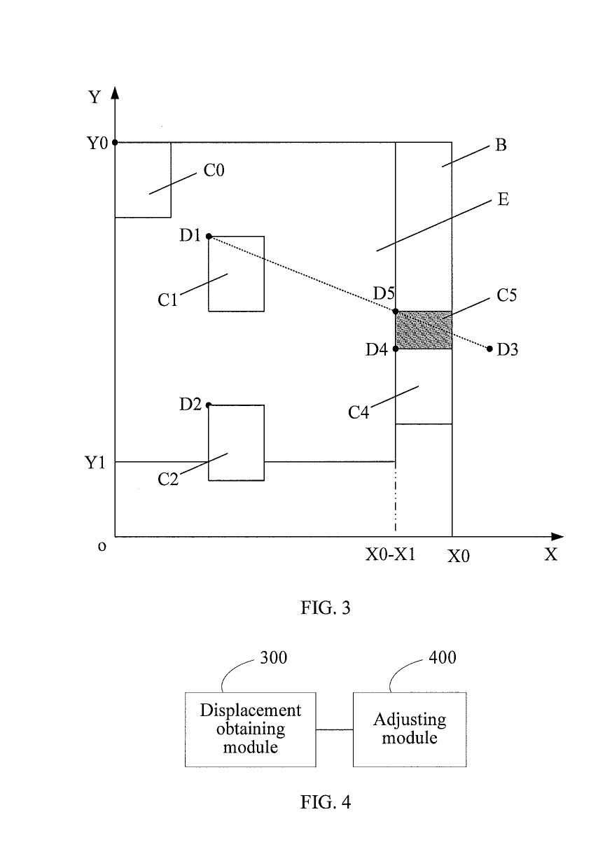

As shown in FIG. 3, it is assumed that in a plane rectangular coordinate system, a left lower corner of a page B is used as an origin point O, a lower border of the page B is used as an X axis, a left border of the page B is used as a Y axis, any point on the page has unique coordinates belonging to the coordinate system XOY. It is assumed that the display origin point of the display screen is a vertex of a left upper corner of the display screen, a vertex of a left upper corner of the current display area is a current locating point. If a vertex of a left upper corner of the page B is used as an initial locating point, when the mobile communication terminal opens the page, the initial locating point is located at the left upper corner of the display screen, so that an area C0 on the most left upper corner of the page is displayed, where the area C0 is a display area using the initial locating point as a vertex of a left upper corner and using a size of the display screen as the size. It is assumed that at the first time point, the display area of the currently browsed page is C1, the current locating point is the vertex D1 of the left upper corner of the display area C1, and the current locating point is marked as the first locating point. Before adjusting the display area of the page, the mobile communication terminal first obtains the coordinates of the first locating point.

202: Obtain coordinates of a second locating point according to the coordinates of the first locating point and the displacement.

A vector sum operation is performed on the negative value of the obtained displacement from the first time point to the second time point and the obtained coordinates of the first locating point, that is, the displacement is subtracted from the coordinates of the first locating point, so as to obtain the coordinates of the second locating point of a display area which should be displayed on the currently browsed page at the second time point. The step may specifically be:

202a: Determine whether new coordinates obtained by subtracting the displacement from the coordinates of the first locating point exceed a locating point coordinate permitted range of the currently browsed page.

The locating point coordinate permitted range is a range which is slightly smaller than the page and is on the page, and a locating point can only be determined within the range. In the following, as shown in FIG. 3, it is described how to determine borders of the locating point coordinate permitted range: It is assumed that a height of the page B is Y0, a width of the page B is X0, a height of the display screen is Y1, a width of the display screen is X1, and the vertex of the left upper corner of the display area of the page is used as the initial locating point, the locating point coordinate permitted range of the currently browsed page is shown in an area E in FIG. 3, and four vertexes of the area E are (0, Y1), (X0-X1, Y1), (X0-X1, Y0), and (0, Y0) respectively. Then, by determining whether the new coordinates obtained by subtracting the displacement from the coordinates of the first locating point exceed the locating point coordinate permitted range, it is decided how to determine the coordinates of the second locating point.

202b: If the new coordinates do not exceed the locating point coordinate permitted range, the new coordinates are used as the coordinates of the second locating point.

As shown in FIG. 3, the new coordinates are D2 within the locating point coordinate permitted range, so that D2 is directly used as the second locating point.

202c: If the new coordinates exceed the locating point coordinate permitted range, coordinates are additionally determined as the coordinates of the second locating point.

If the new coordinates exceed the locating point coordinate permitted range, obviously, the new coordinates cannot be used as the coordinates of the second locating point, and in this embodiment, it is allowed to preset various policies to determine the coordinates of the second locating point.

In one policy, coordinates which are closest to the new coordinates and are within the locating point coordinate permitted range is used as the coordinates of the second locating point. As shown in FIG. 3, the new coordinates are D3 out of the locating point coordinate permitted range, and coordinates D4 which are closest to D3 and are within the locating point coordinate permitted range is used as the coordinates of the second locating point.

In another policy, coordinates of an intersection point of a connection line of the new coordinates and the coordinates of the first locating point and a border of the locating point coordinate permitted range are obtained, and the coordinates of the intersection point is used as the coordinates of the second locating point. As shown in FIG. 3, the new coordinates are D3 out of the locating point coordinate permitted range, an intersection point of a connection line of D3 and D1 and the border of the locating point coordinate permitted range is D5, and coordinates of D5 may be used as the coordinates of the second locating point.

203: Adjust the display area of the currently browsed page at the second time point according to the coordinates of the second locating point.

The step is specifically that: A position which is represented by the coordinates of the second locating point and is on the currently browsed page is placed at the display origin point of the display screen, so as to implement adjusting the display area of the currently browsed page at the second time point.

It is assumed that the display origin point of the display screen is the vertex of the left upper corner of the display screen, the display area of the currently browsed page at the second time point is an area which extends from the vertex of the left upper corner of the second locating point, is on the currently browsed page, and has a same size as that of the display screen, such as the area C0, C1, C2, C4, or C5 shown in FIG. 3, and the area is completely displayed on the display screen.

It should be noted that, in other embodiments, the display origin point of the display screen may be defined according to other manners, for example, the central point of the display screen is defined as the display origin point, and so on. Correspondingly, the locating point may also be a central point of the display area.

To sum up, in this embodiment, by defining a coordinate system, coordinates of a locating point corresponding to each time point may be calculated according to obtained displacement of the mobile communication terminal between two time points, and then a display area is determined according to the coordinates of the locating point.

Referring to FIG. 4, an embodiment of the present invention further provides an apparatus for adjusting a display area of a page, where the apparatus includes:

a displacement obtaining module 300, configured to obtain displacement of a mobile communication terminal from a first time point to a second time point; and

an adjusting module 400, configured to adjust a display area of a currently browsed page according to the displacement.

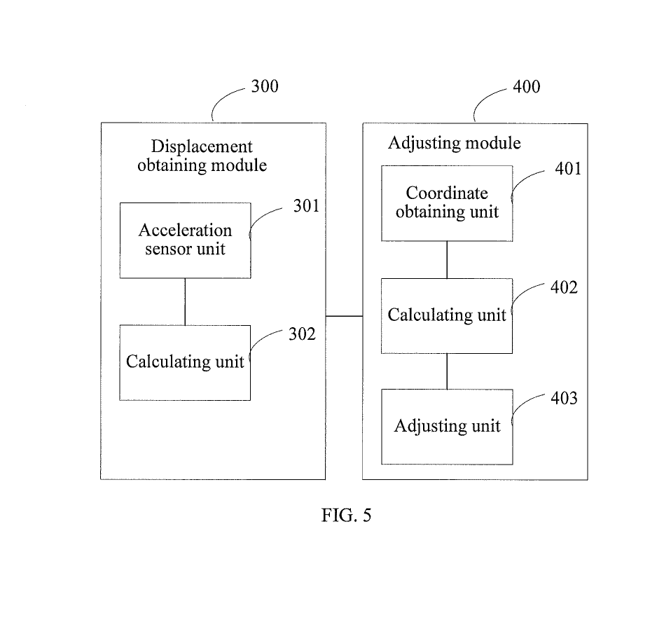

As shown in FIG. 5, in another embodiment:

The displacement obtaining module 300 may further include:

an acceleration sensor unit 301, configured to detect acceleration of the mobile communication terminal from the first time point to the second time point; and

a calculating unit 302, configured to perform an integral calculation on the acceleration, to obtain the displacement of the mobile communication terminal from the first time point to the second time point.

The adjusting module 400 may further include:

a coordinate obtaining unit 401, configured to obtain coordinates of a first locating point on a display area of the currently browsed page at the first time point;

a calculating unit 402, configured to obtain coordinates of a second locating point according to the coordinates of the first locating point and the displacement; and

an adjusting unit 403, configured to adjust a display area of the currently browsed page at the second time point according to the coordinates of the second locating point.

The calculating unit 402 may further include:

a determining unit 402a, configured to determine whether new coordinates obtained by subtracting the displacement from the coordinates of the first locating point exceed a locating point coordinate permitted range of the currently browsed page;

a first calculating unit 402b, configured to, if the determining unit determines that the new coordinates do not exceed the locating point coordinate permitted range, use the new coordinates as the coordinates of the second locating point; and

a second calculating unit 402c, configured to, if the determining unit determines that the new coordinates exceed the locating point coordinate permitted range, additionally determine coordinates as the coordinates of the second locating point.

Further, the second calculating unit 402c may specifically be configured to, if the determining unit determines that the new coordinates exceed the locating point coordinate permitted range, use coordinates which are closest to the new coordinates and are within the locating point coordinate permitted range as the coordinates of the second locating point; or obtain coordinates of an intersection point of a connection line of the new coordinates and the coordinates of the first locating point and a border of the locating point coordinate permitted range, and use the coordinates of the intersection point as the coordinates of the second locating point.

By adopting the apparatus in the embodiment of the present invention in the mobile communication terminal, a user may adjust the display area of the page through the mobile communication terminal, so as to solve a problem in the prior art that a mis-operation is easily caused when the display area of the page is adjusted in a manner of dragging on a touchscreen.

An embodiment of the present invention further provides a mobile communication terminal, where the mobile communication terminal includes a display screen and the apparatus for adjusting a display area of a page provided by the foregoing embodiment.

The mobile communication terminal may be a cell phone, an MP3, an MP4, a man-machine interaction terminal, an electronic book, or other terminal devices having a display function. In a case that the mobile communication terminal is a cell phone, the cell phone further includes: a display screen, a radio frequency circuit, a power supply circuit, and so on; where the display screen is configured to display page content; the radio frequency circuit is configured to establish communication between the cell phone and a wireless network, thereby implementing data receiving and sending between the cell phone and the wireless network, for example, requesting page content; and the power supply circuit is configured to supply power to each circuit or component of the cell phone.

Persons of ordinary skill in the art should understand that all or a part of the steps of various methods in the foregoing embodiments may be implemented by a program instructing relevant hardware. The program may be stored in a computer readable storage medium, and the storage medium may include a memory, a magnetic disk, or an optical disk, or the like.

The method, the apparatus, and the terminal for adjusting a display area of a page provided by the embodiments of the present invention are described in detail in the foregoing. The principle and implementation manners of the present invention are described herein by applying specific examples. The description about the foregoing embodiments is merely provided for ease of understanding of the method and core ideas of the present invention, and shall not be construed as a limitation to the present invention.

What is claimed is:

1. A method for adjusting a display area of a page, comprising:
obtaining displacement of a mobile communication terminal from a first time point to a second time point; and
adjusting a display area of a currently browsed page according to the displacement.

2. The method according to claim 1, wherein the obtaining displacement of a mobile communication terminal from a first time point to a second time point comprises:
detecting acceleration of the mobile communication terminal from the first time point to the second time point; and
performing an integral calculation on the acceleration, to obtain the displacement of the mobile communication terminal from the first time point to the second time point.

3. The method according to claim 1, wherein the adjusting a display area of a currently browsed page according to the displacement comprises:
obtaining coordinates of a first locating point on a display area of the currently browsed page at the first time point;
obtaining coordinates of a second locating point according to the coordinates of the first locating point and the displacement; and
adjusting a display area of the currently browsed page at the second time point according to the coordinates of the second locating point.

4. The method according to claim 3, wherein the obtaining coordinates of a second locating point according to the coordinates of the first locating point and the displacement comprises:
determining whether new coordinates obtained by subtracting the displacement from the coordinates of the first locating point exceed a locating point coordinate permitted range of the currently browsed page, if not, using the new coordinates as the coordinates of the second locating point; and if yes, additionally determining coordinates as the coordinates of the second locating point.

5. The method according to claim 4, wherein the additionally determining coordinates as the coordinates of the second locating point comprises:
using coordinates which are closest to the new coordinates and are within the locating point coordinate permitted range as the coordinates of the second locating point; or
obtaining coordinates of an intersection point of a connection line of the new coordinates and the coordinates of the first locating point and a border of the locating point coordinate permitted range, and using the coordinates of the intersection point as the coordinates of the second locating point.

6. The method according to claim 3, wherein:
the first locating point is a point which coincides with a display origin point of a display screen and is on the display area of the currently browsed page at the first time point.

7. The method according to claim 6, wherein the adjusting a display area of the currently browsed page at the second time point according to the coordinates of the second locating point comprises:
placing a position which is represented by the coordinates of the second locating point and is on the currently browsed page at the display origin point of the display screen, so as to implement adjusting the display area of the currently browsed page at the second time point.

8. The method according to claim 4, wherein: the first locating point is a point which coincides with a display origin point of a display screen and is on the display area of the currently browsed page at the first time point, and wherein the adjusting a display area of the currently browsed page at the second time point according to the coordinates of the second locating point comprises:
placing a position which is represented by the coordinates of the second locating point and is on the currently browsed page at the display origin point of the display screen, so as to implement adjusting the display area of the currently browsed page at the second time point.

9. The method according to claim 5, wherein: the first locating point is a point which coincides with a display origin point of a display screen and is on the display area of the currently browsed page at the first time point, and wherein the adjusting a display area of the currently browsed page at the second time point according to the coordinates of the second locating point comprises:
placing a position which is represented by the coordinates of the second locating point and is on the currently browsed page at the display origin point of the display screen, so as to implement adjusting the display area of the currently browsed page at the second time point.

10. The method according to claim 2, wherein the adjusting a display area of a currently browsed page according to the displacement comprises:
obtaining coordinates of a first locating point on a display area of the currently browsed page at the first time point;
obtaining coordinates of a second locating point according to the coordinates of the first locating point and the displacement; and
adjusting a display area of the currently browsed page at the second time point according to the coordinates of the second locating point.

11. The method according to claim 10, wherein the obtaining coordinates of a second locating point according to the coordinates of the first locating point and the displacement comprises:
determining whether new coordinates obtained by subtracting the displacement from the coordinates of the first locating point exceed a locating point coordinate permitted range of the currently browsed page, if not, using the new coordinates as the coordinates of the second locating point; and if yes, additionally determining coordinates as the coordinates of the second locating point, wherein the additionally determining coordinates as the coordinates of the second locating point comprises:
using coordinates which are closest to the new coordinates and are within the locating point coordinate permitted range as the coordinates of the second locating point; or
obtaining coordinates of an intersection point of a connection line of the new coordinates and the coordinates of the first locating point and a border of the locating point coordinate permitted range, and using the coordinates of the intersection point as the coordinates of the second locating point.

12. The method according to claim 10, wherein: the first locating point is a point which coincides with a display origin point of a display screen and is on the display area of the currently browsed page at the first time point, and wherein the adjusting a display area of the currently browsed page at the second time point according to the coordinates of the second locating point comprises:
placing a position which is represented by the coordinates of the second locating point and is on the currently browsed page at the display origin point of the display screen, so as to implement adjusting the display area of the currently browsed page at the second time point.

13. The method according to claim 11, wherein: the first locating point is a point which coincides with a display origin point of a display screen and is on the display area of the currently browsed page at the first time point, and wherein the adjusting a display area of the currently browsed page at the second time point according to the coordinates of the second locating point comprises:
placing a position which is represented by the coordinates of the second locating point and is on the currently browsed page at the display origin point of the display screen, so as to implement adjusting the display area of the currently browsed page at the second time point.

14. An apparatus for adjusting a display area of a page, comprising:
a displacement obtaining module, configured to obtain displacement of a mobile communication terminal from a first time point to a second time point; and
an adjusting module, configured to adjust a display area of a currently browsed page according to the displacement.

15. The apparatus according to claim 14, wherein the displacement obtaining module comprises:
an acceleration sensor unit, configured to detect acceleration of the mobile communication terminal from the first time point to the second time point; and
a calculating unit, configured to perform an integral calculation on the acceleration, to obtain the displacement of the mobile communication terminal from the first time point to the second time point.

16. The apparatus according to claim 14, wherein the adjusting module comprises:
a coordinate obtaining unit, configured to obtain coordinates of a first locating point on a display area of the currently browsed page at the first time point;
a calculating unit, configured to obtain coordinates of a second locating point according to the coordinates of the first locating point and the displacement; and
an adjusting unit, configured to adjust a display area of the currently browsed page at the second time point according to the coordinates of the second locating point.

17. The apparatus according to claim 16, wherein the calculating unit further comprises:
a determining unit, configured to determine whether new coordinates obtained by subtracting the displacement from the coordinates of the first locating point exceed a locating point coordinate permitted range of the currently browsed page;
a first calculating unit, configured to, if the determining unit determines that the new coordinates do not exceed the locating point coordinate permitted range, use the new coordinates as the coordinates of the second locating point; and
a second calculating unit, configured to, if the determining unit determines that the new coordinates exceed the locating point coordinate permitted range, additionally determine coordinates as the coordinates of the second locating point.

18. The apparatus according to claim 17, wherein:
the second calculating unit is specifically configured to, if the determining unit determines that the new coordinates exceed the locating point coordinate permitted range, use coordinates which are closest to the new coordinates and are within the locating point coordinate permitted range as the coordinates of the second locating point; or obtain coordinates of an intersection point of a connection line of the new coordinates and the coordinates of the first locating point and a border of the locating point coordinate permitted range, and use the coordinates of the intersection point as the coordinates of the second locating point.

19. A mobile communication terminal, comprising a display screen and the apparatus for adjusting a display area of a page according to claim 14.
